(19) United States
(12) Patent Application Publication
(10) Pub. No.: US 2017/0220745 A1
(43) Pub. Date: Aug. 3, 2017

(54) ELECTRONIC DEVICE FOR PROCESSING AND PROVIDING DATA AND OPERATING METHOD THEREOF

(71) Applicant: Samsung Electronics Co., Ltd, Gyeonggi-do (KR)

(72) Inventors: Haedong Lee, Daegu (KR); Kyung-Hee Lee, Gyeonggi-do (KR); Jae-Woong Chun, Gyeonggi-do (KR); Won Suk Choi, Seoul (KR)

(21) Appl. No.: 15/422,328

(22) Filed: Feb. 1, 2017

(30) Foreign Application Priority Data
Feb. 1, 2016 (KR) 10-2016-0012358

(51) Int. Cl. G06F 19/00

(52) U.S. Cl. CPC G06F 19/323

(57) ABSTRACT

Various embodiments of the present disclosure teach a method and apparatus for processing and providing health data. For example, an electronic device may include a memory, and a processor operatively coupled to the memory. The processor is configured to receive a request for health data of a user from an object configured to collect the health data and confirm medical certification information corresponding to the object. The processor may further generate translated health data by performing translation on at least one part of the health data on the basis of the medical certification information, and deliver the translated health data to the object. The object may be an application, a sensor, or a second electronic device configured to collect the health data, and the health data is configured to comprises health data acquired from a different object.

### CROSS-REFERENCE TO RELATED APPLICATION(S) AND CLAIM OF PRIORITY

The present application is related to and claims priority under 35 U.S.C. §119(a) of a Korean Application Ser. No. 10-2016-0012358, which was filed in the Koreans Intellectual Property Office on Feb. 1, 2016, the entire content of which is hereby incorporated by reference.

### TECHNICAL FIELD

Various embodiments of the present disclosure teach a method and apparatus for processing and providing personal health data.

### BACKGROUND

With the development of recent digital technologies, various types of electronic devices are widely used such as a mobile communication terminal, a smart phone, a tablet, a Personal Computer (PC), a Personal Digital Assistant (PDA), an electronic organizer, a notebook, a wearable device, a digital camera, an Internet of Things (IoT), a game device, an audible device, or the like.

Recently, the electronic device is used to provide various services (or functions) for managing a user's health. Meanwhile, according to a privacy rule of a medical information protection act (e.g., HIPAA, Health Insurance Portability and Accountability Act), when the electronic device (e.g., an entity) uses a Personal Health Record (PHR) or transmits it to a different electronic device (e.g., another entity), it is specified that the PHR must be accessed or shared as little as required to satisfy a usage purpose (e.g., a function or service to be provided). Further, for this, it is recommended to introduce a technical procedure.

Accordingly, the conventional electronic device specifies a type of data related to the PHR to be accessed, and allows a user to accept or reject an access right for the specified data type.

However, various health applications may be installed in the electronic device through a store (e.g., App Store) or the like, or the health application configured in the electronic device may be frequently deleted. Further, in an environment in which the electronic device operates by interworking with an accessory or an Internet of Things (IoT), a connection with various external devices (e.g., a sensor) is provided to the electronic device. In this environment, whether it is medically certified may be frequently changed according to the installed application or the sensor connected to the electronic device. Further, a service level and a type of a service which can be handled by the sensor or the application may vary depending on whether it is medically certified.

### SUMMARY

If an electronic device only accepts or rejects health data to be accessed, it may be difficult to access or provide the data by considering various service levels. For example, a sensor or an application may handle data of various service levels also for one service, and may have different rights (e.g., whether it is medically certified) respectively for various services. Further, the right may be frequently acquired, expired, or rejected for each of the various services. Accordingly, it may be difficult to access or provide data on the basis of the various service levels.

To address the above-discussed deficiencies, it is a primary object to provide a method and apparatus for deciding whether health data to be accessed or provided is medically certified according to a service level which can be provided by a sensor or an application in an electronic device, and for providing data through proper processing based on a purpose of providing the data.

Various embodiments disclose a method and apparatus for deciding health data suitable for a purpose of providing data of a different electronic device upon receiving a request for the health data from the different electronic device, and for providing data by performing translation on the data into health data on the basis of a result of the decision,.

According to various embodiments of the present disclosure, an electronic device may include a memory, and a processor operatively coupled to the memory. The processor may be configured to receive a request for health data of a user from at least one object configured to collect the health data, confirm medical certification information corresponding to the at least one object, generate translated health data by performing translation on at least one part of the health data on the basis of at least the medical certification information, and deliver the translated health data to the at least one object.

According to various embodiments of the present disclosure, a method of operating an electronic device may include receiving a request for health data of a user from at least one object configured to collect the health data, confirming medical certification information corresponding to the at least one object, generating translated health data by performing translation on at least one part of the health data on the basis of at least the medical certification information, and delivering the translated health data to the at least one object.

In order to solve the aforementioned problem, various embodiments of the present disclosure may include a computer readable recording medium having a program for allowing a processor to execute the above method.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments;

FIG. 2 is a block diagram illustrating an electronic device according to various embodiments;

FIG. 3 is a block diagram illustrating a program module according to various embodiments;

FIG. 4 illustrates an operation according to various embodiments of the present disclosure;

FIG. 5 illustrates a structure of an electronic device according to various embodiments of the present disclosure;

FIG. 6 illustrates a program module for processing health data in an electronic device, according to various embodiments of the present disclosure;

FIG. 7 illustrates an operation for processing health data in an electronic device according to various embodiments of the present disclosure;

FIG. 8 is a flowchart illustrating a method of operating an electronic device according to various embodiments of the present disclosure;

FIG. 9 is a flowchart illustrating a method of operating an electronic device according to various embodiments of the present disclosure;

FIG. 10 is a flowchart illustrating a method of operating an electronic device according to various embodiments of the present disclosure;

FIG. 11 illustrates a series of operations of an electronic device according to various embodiments of the present disclosure;

FIG. 12 illustrates an operation of providing data in an electronic device according to various embodiments of the present disclosure;

FIG. 13 illustrates a screen which outputs health data in an electronic device according to various embodiments of the present disclosure; and

FIG. 14 and FIG. 15 illustrate a screen for outputting health data in an electronic device according to various embodiments of the present disclosure.

### DETAILED DESCRIPTION

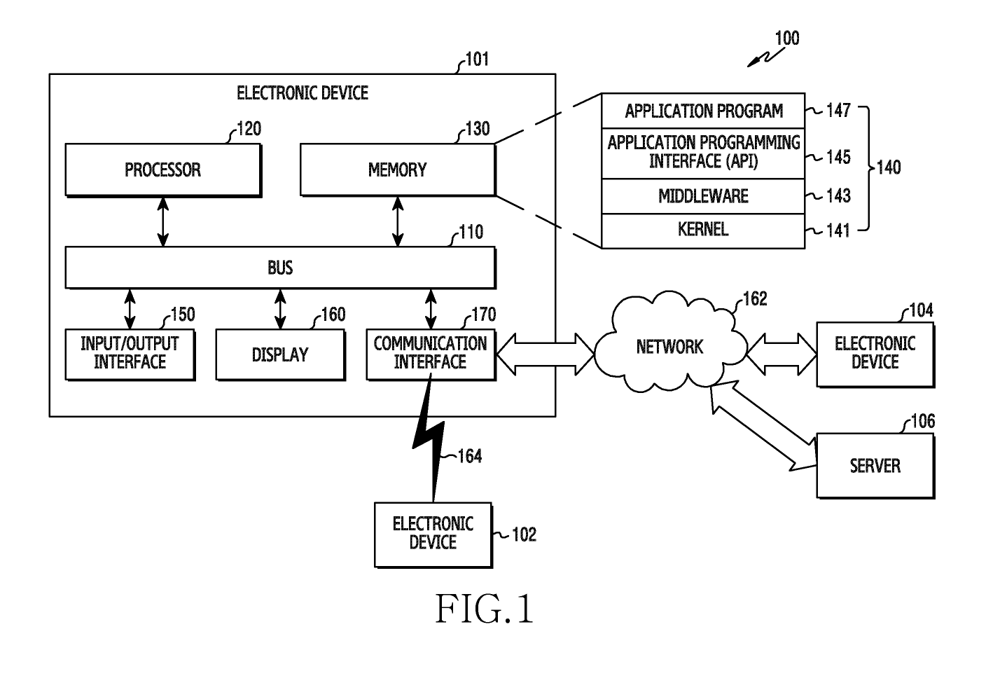

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

FIG. 1 illustrates a network environment including an electronic device according to various embodiments of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106).The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS). GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

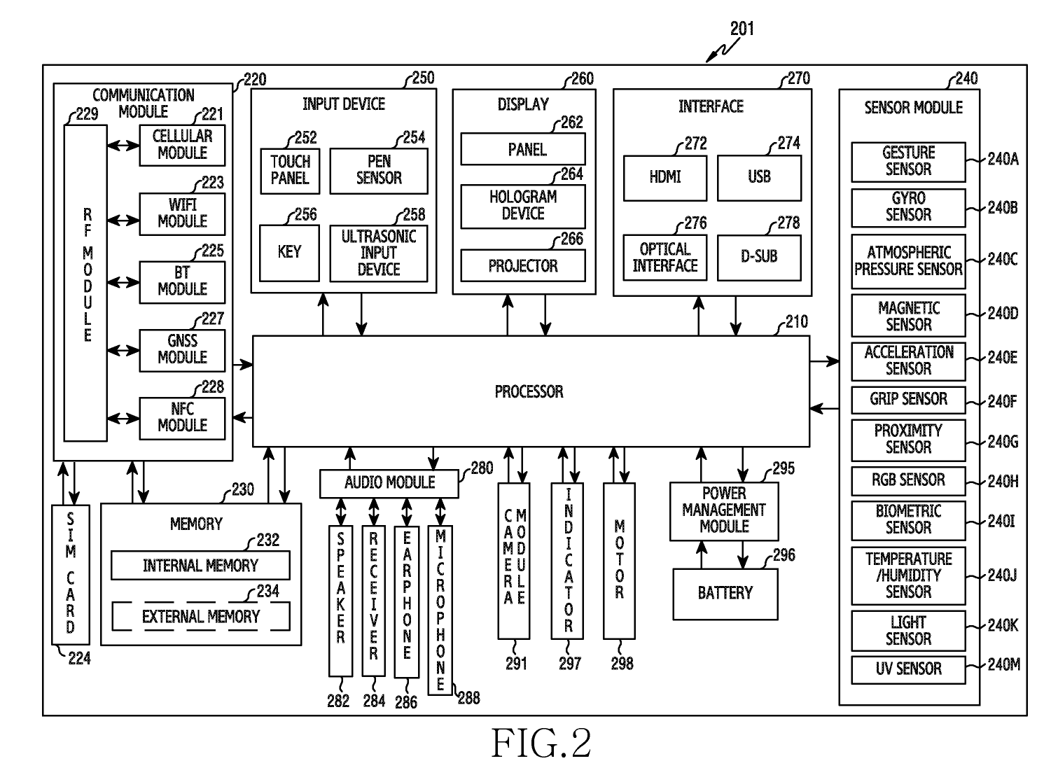

FIG. 2 is a block diagram of an electronic device according to various embodiments of the present disclosure.

The electronic device 201 may include, for example, all or a part of the electronic device 101 shown in FIG. 1. The electronic device 201 may include one or more processors 210 (e.g., Application Processors (AP)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module 227, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using the subscriber identification module 224 (for example, the SIM card). According to an embodiment of the present disclosure, the cellular module 221 may perform at least some of the functions that the AP 210 may provide. According to an embodiment of the present disclosure, the cellular module 221 may include a communication processor (CP).

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the WIFI module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 240I, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

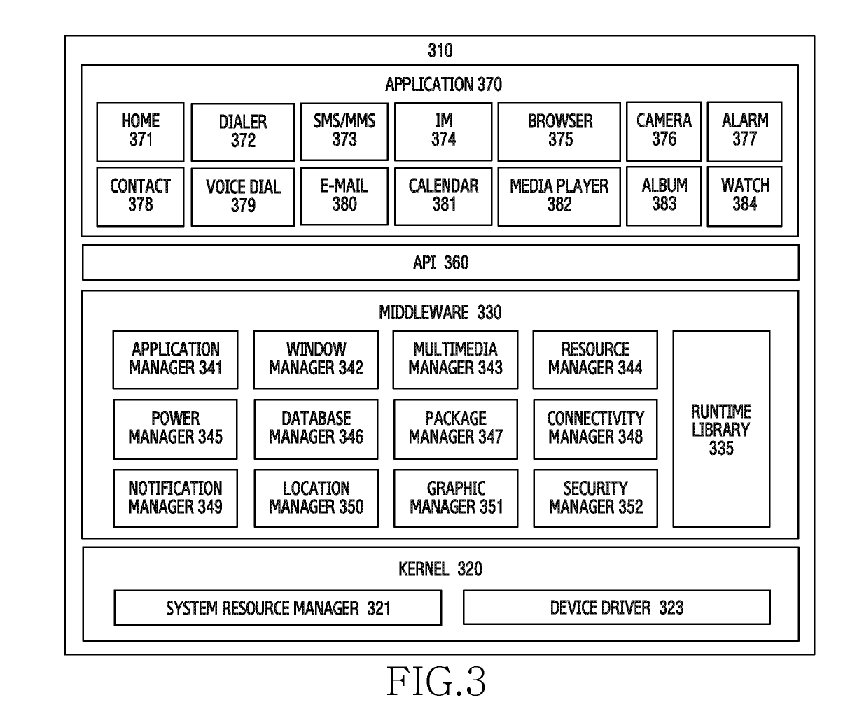

FIG. 3 is a block diagram of a program module according to various embodiments of the present disclosure.

According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android™, iOS™, Windows™, Symbian™, Tizen™, Bada™, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen™, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar), or environment information (e.g., providing atmospheric pressure, humidity, or temperature information).

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 1410). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

Various embodiments of the present disclosure disclose processing and providing health data in an electronic device. According to the various embodiments, the electronic device may collect a variety of body or bio information of a user through an internal sensor or a sensor of an external electronic device, and may generate health data of the user on the basis of at least one part of the collected information. According to the various embodiments, the electronic device may interpret the generated health data, and may provide (e.g., output, transmit) a related service differently depending on a result of interpreting the health data. The electronic device may share the health data between various different electronic devices. According to the various embodiments, an operation of processing and providing the health data by the electronic device is described with reference to the accompanying drawings.

An electronic device according to various embodiments of the present disclosure may include all devices using one or more of various processors such as an Application Processor (AP), a Communication Processor (CP), a Graphic Processing Unit (GPU), a Central Processing Unit (CPU), or the like. For example, the electronic device according to the various embodiments may include all information communication devices, multimedia devices, wearable devices, Internet of Things (IoT) devices, or application devices supporting a function of interpreting and processing health data.

According to various embodiments, a medical certification may be used as a term referring to a case of satisfying a criterion prepared for a device or application for providing a medical service from an organization having a certification right such as Foods and Drugs Administration (FDA) or the like, or a case of acquiring a level equivalent thereto.

In various embodiments, a medical electronic device may be used as a term referring to a device including medical certification information, as an electronic device (including a sensor) which includes a medical function and which is medically certified.

In various embodiments, a medical application may be used as a term including medical certification information, as an application which includes a medical service and which is medically certified.

In various embodiments, a non-medical electronic device may be used as a term including an electronic device (including a sensor) which is not medically certified or which does not include medical certification information.

In various embodiments, a non-medical application may be used as a term including an application which is not medically certified or which does not include medical certification information.

In various embodiments, health data may be used as a term including a user-related body/bio data set acquired or processed from a user input or an electronic device. According to the various embodiments, the health data may include, for example, body information (e.g., a height, a weight, an eyesight, a hearing, a skin condition, etc.), bio signal information (e.g., a blood pressure, a blood flow rate, a blood sugar, a heart rate, an electromyogram, an electroencephalogram, etc.), exercise information (e.g., an exercise amount, calorie consumption, an exercise type, etc.), nutrition information (e.g., a menu, an amount of meal, a calorie intake, a nutrition intake, etc.), or the like. In the various embodiments, the health data may be acquired through an electronic device or a different device (e.g., an external device, a sensor, a medical device, a database, an accessory, etc.) connected to the electronic device in a wired/wireless manner, a user input, or the like.

According to various embodiments, the health data may be implemented in an extensible data type such as eXtensible Markup Language (XML) or the like, or may be implemented based on a general-purpose data structure used in a standard such as Health Level Seven international (HL7) or the like. According to the various embodiments, the health data may include at least one part of information as shown in the example of Table 1 below.

TABLE 1

| Health data | Note |
|---|---|
| ID | Data identifier |
| User | User of the data (Owner) |
| Data type | Type of data |
| Data | Sensing or processing the raw data, |
| | Interpreted data itself |
| Whether medical | Whether data is generated for the |
| purpose | medical purpose |
| Translation type | Information for the |
| | data conversion scheme |

Referring to Table 1, in various embodiments, the health data may include at least one part of information such as an IDentifier (ID), a user, a data type, data, whether it is for a medical purpose, a translation type, or the like. According to the various embodiments, an ID item may indicate an identifier of data. A user item may indicate a user, for example, an owner, of data. A data type item may indicate a type of data. A data item may indicate raw data (or unprocessed data) sensed or processed in regards to a health of the user or interpreted data itself. An item indicating whether it is for the medical purpose may indicate whether data is generated for the medical purpose. A translation type item may include information regarding which translation scheme is used in data.

In various embodiments, a health data type may be used as a term referring to a criterion of classifying health data. For example, the health data type may include a variety of information regarding a body figure (e.g., figure information such as a height, a weight, an eyesight, a hearing, a skin condition, etc.), a sleep, a blood flow rate, a blood sugar, a heart rate, a biorhythm, an electromyogram, an electroencephalogram, an amount of meal, a calorie intake, a nutrition intake, a step count, or the like.

According to various embodiments, raw data (or unprocessed data) may be used as a term referring to unprocessed data read (or acquired) through a sensor, and may include, for example, a signal or a waveform or the like.

In various embodiments, interpreted data may be used as a term referring to data interpreted by processing raw data, so as to be meaningfully used by a specific module or user. For example, the interpreted data may include various types of data such as a value, a statistics (e.g., a maximum, a minimum, a mean, a mode, a deviation, etc.), a graph, a diagnosis, a classification, a recommendation, a coaching, or the like. In the various embodiments, the interpreted data may be translated into data processed several time when a high level service is used. For example, new interpreted data may be derived from a set of the interpreted data, and may be translated into diagnosis information or prescription information by using a processing result for a medical purpose.

In various embodiments, control data may be used as a term referring to data including an instruction for controlling at least one of an electronic device and a sensor.

In various embodiments, medical control data may be used as a term referring to data including a control instruction for controlling at least one of an electronic device or sensor which is medically certified or for controlling a function which needs to be medically certified.

Hereinafter, an operating method and apparatus will be described according to various embodiments with reference to the accompanying drawings. However, since the various embodiments of the present disclosure are not restricted or limited by the content described below, it should be noted that the present disclosure is applicable to the various embodiments on the basis of embodiments described below. A hardware-based access method is described for example in the various embodiments of the present disclosure described hereinafter. However, since the various embodiments of the present disclosure include a technique in which hardware and software are both used, a software-based access method is not excluded in the embodiments of the present disclosure.

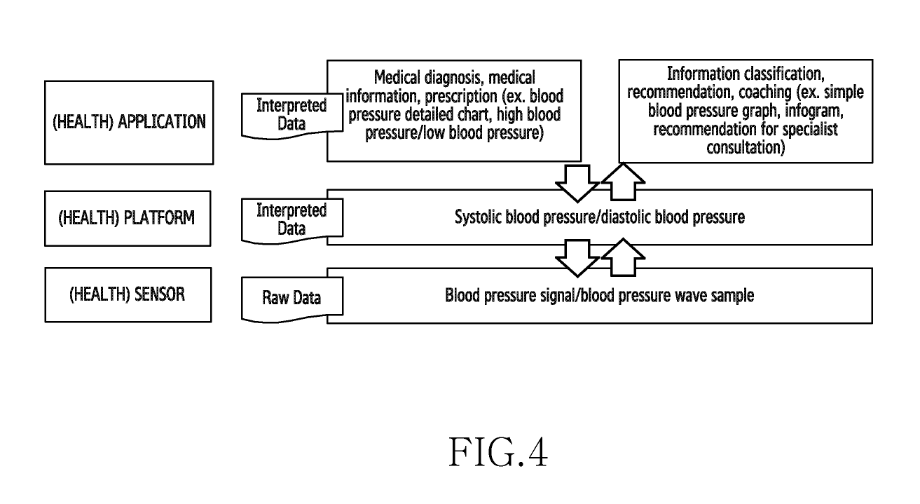

FIG. 4 illustrates an operation according to various embodiments of the present disclosure.

As shown in FIG. 4, in various embodiments, an electronic device may be determined as a medical electronic device (or application) or a non-medical electronic device (or application) according to whether the electronic device includes or provides a medical related function (e.g., a health related application, a platform, a sensor, etc.). According to the various embodiments, in case of a normal electronic device which is not medically certified (e.g., a non-medical electronic device), the normal electronic device may be changed to the medical electronic device when an application or the like for performing a medical function is installed.

According to various embodiments, a service which can be provided by the electronic device (or application) may vary depending on whether it is medically certified. According to one embodiment, raw data (or unprocessed data) (e.g., a blood pressure signal, a blood pressure waveform sample) measured through a health related sensor may be interpreted in a health related platform, and interpreted data (e.g., a systolic blood pressure, a diastolic blood pressure) may be delivered to the application. The electronic device (or application) may decide a delivery target (e.g., a reception target electronic device (or application)) of interpreted data delivered in a platform end (e.g., deciding whether it is medically certified), and may provide the data to be delivered (e.g., interpreted data) by processing or translating the data according to whether the delivery target is medically certified. For example, as described above, different health data may be provided to the medical electronic device (or application) and the non-medical electronic device (or application).

According to one embodiment, the medical electronic device (or application) may indicate a medical electronic device (or application) capable of providing direct medical information such as medical diagnosis, medical information, medical prescription, or the like. According to one embodiment, the medical electronic device may indicate a device capable of providing a detailed blood pressure chart, a medical diagnosis (e.g., whether a blood pressure is high/low or the like), detailed medical information, and prescription on the basis of health data.

According to one embodiment, the non-medical electronic device (or application) may indicate a device capable of providing indirect medical information such as information classification, recommendation, coaching, or the like. According to one embodiment, the non-medical electronic device may indicate a device (or application) capable of providing a simple blood pressure graph, infogram, simple information classification (e.g., recommendation for specialist consultation), recommendation, or coaching.

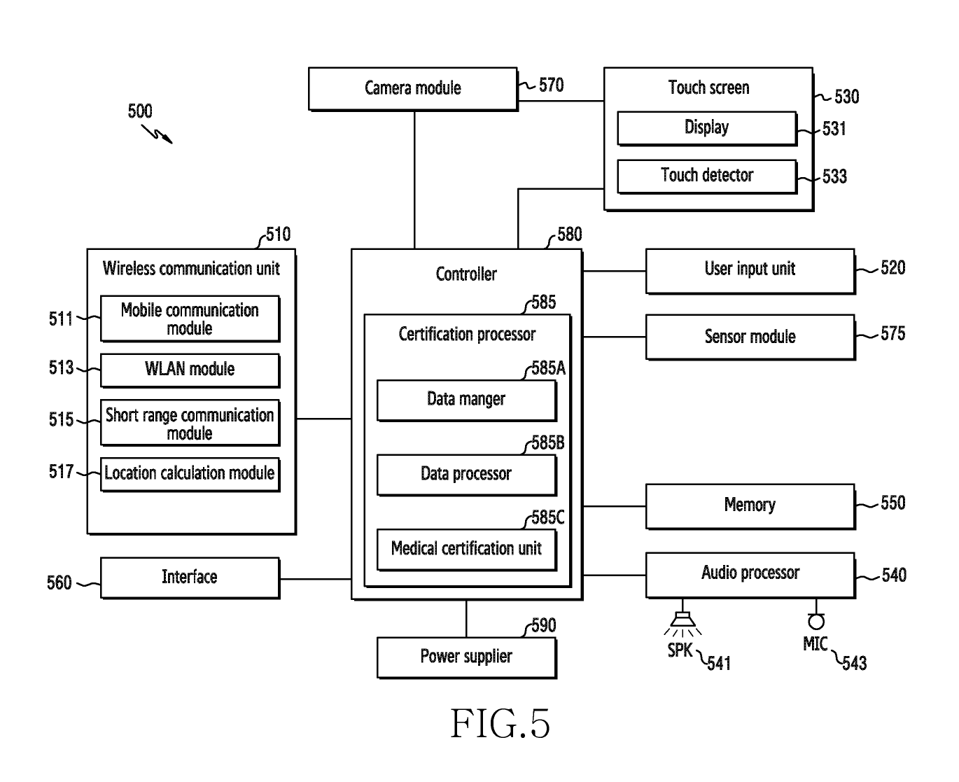

FIG. 5 briefly illustrates a structure of an electronic device according to various embodiments of the present disclosure.

Referring to FIG. 5, an electronic device 500 according to various embodiments of the present disclosure may include, for example, a wireless communication unit 510, a user input unit 520, a touch screen 530, an audio processor 540, a memory 550, an interface 560, a camera module 570, a sensor module 575, a controller 580 (e.g., the processor 120), and a power supplier 590. In the various exemplary embodiments of the present disclosure, the electronic device 500 is not necessarily constructed of components of FIG. 5, and thus the number of components thereof may be greater than or less than the number of components of FIG. 5.

The wireless communication unit 510 may be constructed identically or similarly, for example, to the communication module 220 of FIG. 2. The wireless communication unit 510 may include one or more modules for enabling wireless communication between the electronic device 500 and a different external electronic device (e.g., the electronic device 102 or 104, the server 106). For example, the wireless communication unit 510 may include a mobile communication module 511, a Wireless Local Area Network (WLAN) module 513, a short range communication module 515, a location calculation module 517, or the like. In various embodiments, the wireless communication unit 510 may include a module for performing communication with a neighboring external electronic device (e.g., a short range communication module, a long range communication module, or the like).

The mobile communication module 511 may be constructed identically or similarly, for example, to the cellular module 221 of FIG. 2. The mobile communication module 511 may transmit/receive a radio signal with respect to at least one of a base station, an external electronic device (e.g., the different electronic device 104), and various servers (e.g., an application server, a management server, an integration server, a provider server, a content server, an internet server, a cloud server, etc.) on a mobile communication network. The radio signal may include a voice signal, a data signal, or various types of control signals. The mobile communication module 511 may transmit a variety of data required for an operation of the electronic device 500 to an external device (e.g., the server 106 or the different electronic device 104 or the like) in response to a user request.

The WLAN module 513 may be constructed identically or similarly, for example, to the WiFi module 223 of FIG. 2. The WLAN module 513 may indicate a module for establishing a WLAN link with respect to a wireless Internet access and the different external electronic device (e.g., the different electronic device 102 or the server 106 or the like). The WLAN module 513 may be placed inside or outside the electronic device 500. A wireless Internet technique may use Wireless Fidelity (WiFi), Wireless broadband (Wibro), World interoperability for Microwave access (WiMax), High Speed Downlink Packet Access (HSDPA), millimeter Wave (mmWave), or the like. The WLAN module 513 may transmit a variety of data of the electronic device 500 to the outside or receive the data from the outside by interworking with the different external electronic device (e.g., the different electronic device 102, etc.) connected to the electronic device 500 through a network (e.g., the wireless Internet network) (e.g., the network 162). The WLAN module 513 may remain in an on-state, or may be turned on/turned off according to a configuration of the electronic device 500 or a user input.

The short range communication module 515 may indicate a module for performing short range communication. A short range communication technique may use Bluetooth®, Bluetooth® Low Energy (BLE), Radio Frequency IDentification (RFID), Infrared Data Association (IrDA), Ultra Wideband (UWB), ZigBee, Near Field Communication (NFC), or the like. The short range communication module 515 may transmit a variety of data of the electronic device 500 to the outside or receive the data from the outside by interworking with the different external electronic device (e.g., the different electronic device 102, etc.) connected to the electronic device 500 through a network (e.g., a short range communication network). The short range communication module 515 may remain in an on-state, or may be turned on/turned off according to a configuration of the electronic device 500 or a user input.

The location calculation module 517 may be constructed identically or similarly, for example, to the GNSS module 227 of FIG. 2. The location calculation module 517 is a module for acquiring a location of the electronic device 500, and a representative example thereof may include a Global Position System (GPS) module. The location calculation module 517 may measure the location of the electronic device 500 according to a triangulation principle.

The user input unit 520 may generate input data for controlling the operation of the electronic device 500 in response to a user input. The user input unit 520 may include at least one input means for detecting various user inputs. For example, the user input unit 520 may include a key pad, a dome switch, a physical button, a touch pad (static pressure/electrostatic), jog & shuttle, a sensor (e.g., the sensor module 240), or the like.

The user input unit 520 may be partially implemented outside the electronic device 500 in a button form, and may be partially or entirely implemented with a touch panel. The user input unit 520 may receive a user input for initiating the operation (e.g., a function of processing and providing health data (e.g., a medical certification function, a data processing function based on whether it is medically certified, a data transmission function), etc.) of the electronic device 500 according to various embodiments of the present disclosure, and may generate an input signal based on the user input.

The touch screen 530 indicates an input/output device capable of simultaneously performing an input function and a display function, and may include a display 531 (e.g., the display 160 or 260) and a touch detector 533. The touch screen 530 provides an input/output interface between the electronic device 500 and the user, and may deliver a touch input of the user to the electronic device 500, or may play a mediation role for showing an output from the electronic device 500 to the user. The touch screen 530 may show a visual output to the user. The visual output may be shown in a form of a text, a graphic, a video, and a combination of them.

The display 531 may display (output) a variety of information processed in the electronic device 500. For example, the display 531 may display a User Interface (UI) or a Graphic UI (GUI) related to an operation of displaying translated health data by the electronic device 500 according to whether it is medically certified. Various displays (e.g., the display 160) may be used as the display 531.

In various embodiments, the display 531 may include a flat-type display or a bended display capable of being bent or curved without damage through a substrate which is as thin and flexible as paper. The bended display may maintain a curved shaped by being be engaged with a housing (or a main body including the components of the electronic device 500) of the electronic device 500. In the various embodiments, the electronic device 500 may be implemented not only with a shape of a bended display but also with a display device capable of being freely folded or unfolded similarly to a flexible display. In the various embodiments, the display 531 provides flexibility such that it can be folded and unfolded by replacing a glass substrate with a plastic film. The glass substrate surrounds a liquid crystal in a Liquid Crystal Display (LCD), a Light Emitting Diode (LED), an Organic LED (OLED), an Active Matrix OLED (AMOLED), or the like.

The touch detector 533 may be mounted on the display 531, and may detect a user input which is in contact with or approaches to a surface of the touch screen 530. The user input may include a touch event or a proximity event which is input based on at least one of a single-touch, a multi-touch, a hovering, and an air gesture. In various embodiments, the touch detector 533 may receive a user input for initiating an operation related to the use of the electronic device 500 (e.g., a function of processing and providing health data (e.g., a medical certification function, a data processing function based on whether it is medically certified, a data transmission function)), and may generate an input signal based on the user input.

According to various embodiments, the touch detector 533 may be implemented to be able to receive a force touch input. According to one embodiment, the touch detector 533 may include a pressure sensor (or a force sensor) capable of measuring a strength of pressure for a user's touch. The pressure sensor may be implemented integrally with the touch detector 533, or may be implemented separately with one or more sensors different from the touch detector 533. The touch detector 533 may be mounted on the display 531, and may detect a user input which is in contact with or approaches to a surface of the display 531. The touch detector 533 may be configured to translate a change in a pressure applied to a specific portion of the display 531 or a capacitance or the like which is generated at a specific portion of the display 531 into an electrical input signal. The touch detector 533 may detect a location and area in which an input tool (e.g., a user's finger, an electronic pen, etc.) is in touch with or approaches to the surface of the display 531. Further, the touch detector 533 may be implemented to be able to detect up to a pressure (e.g., a force touch) when a touch is made according to an applied touch mechanism.

The audio processor 540 may be constructed identically or similarly, for example, to the audio module 280 of FIG. 2. The audio processor 540 may perform a function of transmitting an audio signal input from the controller 580 to a speaker (SPK) 541 and delivering an audio signal such as a voice or the like input from a microphone (MIC) 543 to the controller 580. The audio processor 540 may output voice/sound data by translating it into an audible sound through the SPK 541 under the control of the controller 580, and may deliver an audio signal such as a voice or the like received from the MIC 543 by translating it into a digital signal.

The SPK 541 may output audio data received from the wireless communication unit 510 or stored in the memory 550. The SPK 541 may output a sound signal related to various operations (functions) performed in the electronic device 500.

The MIC 543 may receive an external sound signal, and may process it as electrical voice data. Various noise reduction algorithms may be implemented in the MIC 543 to remove a noise generated in a process of receiving the external sound signal. The MIC 543 may manage an input of audio streaming such as a voice instruction (e.g., a voice instruction for initiating a function of processing and providing health data).

The memory 550 (e.g., the memory 130 or 230) may store one or more programs executed by the controller 580, and may perform a function for temporarily storing data to be input/output. The data to be input/output may include, for example, a file such as health data (e.g., raw data, interpreted data, etc.), a video, an image, a photo, an audio, or the like. The memory 550 may play a role of storing acquired data in such a manner that data acquired on a real-time basis is stored in a temporary storage device (e.g., a buffer) and data confirmed to be stored is stored in a long-term storage device.

In various embodiments, the memory 550 may store one or more programs, data, or instructions for allowing the controller 580 (e.g., the processor) to receive a request for health data of a user from at least one object configured to collect the health data, confirm medical certification information corresponding to the at least one object, generate translated health data by performing translation on at least one part of the health data on the basis of at least the medical certification information, and deliver the translated health data to the at least one object.

According to various embodiments, the memory 500 may store one or more programs, data, or instructions for generating the translated health data from at least one part of the health data by using a first translation scheme if the medical certification information corresponds to first medical certification information, and generating the translated health data from the at least one part of the health data if the medical certification information corresponds to second medical certification information.

According to various embodiments, the memory 550 may include one or more application modules (or software modules). In the various embodiments, the memory 550 may include a computer readable recording medium having a program for allowing the processor (e.g., the controller 580) to execute the method according to the various embodiments.

According to various embodiments, a computer readable recording medium may include, for example, a computer readable recording medium having a program for executing operations of receiving a request for health data of a user from at least one object (e.g., an application, a sensor, a different electronic device, etc.) configured to collect the health data, confirming medical certification information corresponding to the at least one object, generating translated health data by performing translation on at least one part of the health data on the basis of at least the medical certification information, and delivering the translated health data to the at least one object.

The interface 560 may be constructed identically or similarly, for example, to the interface 270 of FIG. 2. The interface 560 may receive data transmitted from the different electronic device, or may deliver supplied power to each component inside the electronic device 500. The interface 560 may allow data inside the electronic device 500 to be transmitted to the different electronic device. For example, a wired/wireless headphone port, an external charger port, a wired/wireless data port, a memory card port, an audio input/output port, a video input/output port, an earphone port, or the like may be included in the interface 560.

The camera module 570 (e.g., the camera module 291) is configured to support a capturing function of the electronic device 500. The camera module 570 may capture any subject under the control of the controller 580, and may deliver captured data (e.g., an image) to the display 531 and the controller 580. The camera module 570 may include an image sensor (e.g., a Charged Coupled Device (CCD) or a Complementary Metal-Oxide Semiconductor (CMOS)).

According to various embodiments, the camera module 570 is configured to support a capturing function of the electronic device 500. The camera module 570 may capture any subject under the control of the controller 580, and may deliver captured data (e.g., an image) to the display 531 and the controller 580. According to the various embodiments, the camera module 570 may include, for example, a first camera (e.g., a color (RGB) camera) for acquiring color information and a second camera (e.g., an InfraRed (IR) camera) for acquiring depth information (e.g., location information and distance information of the subject). The camera module 570 may include an image sensor. The image sensor may be implemented with a Charged Coupled Device (CCD) or a Complementary Metal-Oxide Semiconductor (CMOS). According to one embodiment, the first camera may be a front camera provided in a front surface of the electronic device 500. According to the various embodiments, the front camera may be replaced with the second camera, and may not be provided in the front surface of the electronic device 500. According to the various embodiments, the first camera may be disposed to the front surface of the electronic device 500 together with the second camera. According to one embodiment, the first camera may be a rear camera provided in a rear surface of the electronic device 500. According to one embodiment, the first camera may include both of the front camera and the rear camera which are provided respectively to the front surface and the rear surface of the electronic device 500.

The sensor module 575 may be constructed identically or similarly to the sensor module 240 of FIG. 2. In various embodiments, the sensor module 575 may detect a movement and motion of the electronic device 500, and may provide sensing information based on a result of the detection to the controller 580. According to the various embodiments, the sensor module 240 may measure a user's body or bio information, and may provide sensing information based thereon to the controller 580. The sensor module 575 may include various sensors, for example, a heart rate sensor, a blood pressure sensor, a body temperature sensor, a blood sugar sensor, a fingerprint sensor, a gyro sensor, an acceleration sensor, an angular velocity sensor, a GPS sensor, a rotation detection sensor, or the like.

The controller 580 (e.g., the processor, the control circuit) may provide an overall control to the electronic device 500. In various embodiments, the controller 580 may be constructed identically or similarly, for example, to the processor 210 of FIG. 2. In the various embodiments, the controller 580 may control an operation related to translating and providing health data on the basis of medical certification information of the electronic device 500 and/or the external electronic device. For example, the controller 580 may process an operation of receiving a request for user's health data from at least one object (e.g., an application, a sensor, or a different electronic device) configured to collect health data, an operation of conforming medical certification information corresponding to at least one object, an operation of generating health data translated by performing translation on at least one part of the health data, and an operation of delivering the translated health data into at least one object.

The controller 580 may include one or more processors for controlling the operation of the electronic device 500. For example, the controller 580 may include a Communication Processor (CP), an Application Processor (AP), an interface (e.g., a General Purpose Input/Output (GPIO)), an internal memory, or the like as separate constitutional elements, or may be integrated with one or more Integrated Circuits (IC s). According to one embodiment, the AP may perform several functions for the electronic device 500 by executing various types of software programs, and the CP may process and control voice communication, video communication, and data communication. The controller 580 execute a specific software module (e.g., an instruction set) stored in the memory 550 to play a role of performing specific several functions corresponding to the module.

In various embodiments, the controller 580 may control an operation of a hardware module such as the audio processor 540, the interface 560, the display 531, the camera module 570, the sensor module 575, or the like. According to the various embodiments, the controller 580 may be electrically and/or operatively coupled to the wireless communication unit 510, display 531, and memory 550 of the electronic device 500.

An operation of controlling (or processing) the controller 580 will be described in detail with reference to drawings described below according to various embodiments of the present disclosure.

According to various embodiments of the present disclosure, the controller 580 may be implemented with one or more processors for controlling the operation of the electronic device 500 according to the various embodiments of the present disclosure by executing one or more programs stored in the memory 550.

According to various embodiments of the present disclosure, the controller 580 may include a certification processor 585 for processing a function related to processing, translating, and providing of health data. According to the various embodiments, the certification processor 585 may include, for example, a data manger 585A, a data processor 585B, a medical certification unit 585C, or the like.

According to various embodiments, a process performed by the data manager 585A may include acquiring, delivering, storing, or the like of health data and/or control data. For example, the data manager 585A may receive a request of data which intends to have access to an application (e.g., the application 370 of FIG. 3) through an API (e.g., the API 145 or 360) or the like, and may deliver control data to a sensor (e.g., the sensor module 575) to which the application intends to have access through the API or the like.

According to various embodiments, a process performed by the data processor 585B may include interpreting, translating, or the like of health data and/or control data. According to the various embodiments, as at least one part of the function, the data processor 585B may be configured by including a data interpreter, a data translation scheme determining unit, a data translation unit, or the like.

According to various embodiments, the medical certification unit 585C may request and receive medical certification information as to the electronic device or the application, and thus may decide whether it is medically certified. The medical certification unit 585C may determine whether the electronic device is a medical electronic device or a non-medical electronic device according to whether it is medically certified. In the various embodiments, the medical certification unit 585C may decide whether to perform medical certification on a target for receiving data, in order to reduce or prevent data delivered by the data manager 585A from being delivered to the non-medical electronic device or the non-medical application in a state of including information more than necessary. The medical certification unit 585C may perform determining and processing of a data processing method through the data processor 585B according to whether it is medically certified.

The power supplier 590 may supply power required for an operation of each constitutional element by receiving external power and internal power under the control of the controller 580. In various embodiments of the present disclosure, the power supplier 590 may supply or turn on/off power to the display 531, the camera module 570, the sensor module 575, or the like under the control of the controller 580.

As described above, the electronic device 500 according to various embodiments of the present disclosure may include the memory 550 and the processor (e.g., the controller 580) operatively coupled to the memory 550. The processor may be configured to receive a request for health data of a user from at least one object configured to collect the health data, confirm medical certification information corresponding to the at least one object, generate translated health data by performing translation on at least one part of the health data on the basis of at least the medical certification information, and deliver the translated health data to the at least one object.

According to various embodiments, the at least one object may be configured to include an application, sensor, or a different electronic device configured to collect the health data.

According to various embodiments, the processor may be configured to generate the translated health data from at least one part of the health data by using a first translation scheme if the medical certification information corresponds to first medical certification information, and generate the translated health data from the at least one part of the health data if the medical certification information corresponds to second medical certification information.

According to various embodiments, the processor may be configured to confirm a health data usage of the at least one object on the basis of the medical certification information, and perform the translation on the basis that the health data includes data in a wider range than a range of data corresponding to the usage.

According to various embodiments, the health data may be configured to include health data acquired from an object different from the at least one object.

According to various embodiments, the processor may be configured to acquire the health data by using a sensor different from the at least one object in response to the request.

According to various embodiments, the processor may be configured to acquire the health data from an application different from the at least one object in response to the request.

According to various embodiments, the processor may be configured to request a different electronic device to provide the health data in response to the request.

According to various embodiments, the processor may be configured to confirm medical certification information stored in the electronic device and medical certification information stored in the external electronic device.

According to various embodiments, the processor may be configured to perform the translation on at least one part of the health data by using at least one translation scheme among simplifying, categorizing, abstracting, and deleting.

According to various embodiments, the processor may be configured to select a source of health data corresponding to an item configured to display health information, decide medical certification information corresponding to the source, display a certification identifier in association with the item on the basis of the medical certification information, and display the health data in association with the item.

According to various embodiments, the processor may be configured to provide the health data in a first form in response to a selection of an application which is medically certified, and provide the health data in a second form in response to a selection of an application which is not medically certified.

According to various embodiments, the processor may be configured to provide the health data on the basis of detailed medical information upon selection of the application which is medically certified, and provide the health data on the basis of simple medical information upon selection of the application which is not medically certified.

According to various embodiments, the processor may be configured to provide the simple medical information by using at least one translation scheme among simplifying, categorizing, abstracting, and deleting.

According to various embodiments, the processor may be configured to decide whether the selected application is medically certified in response to the selection of the application, and display medical certification information in association with the selected application on the basis of a result of the decision.

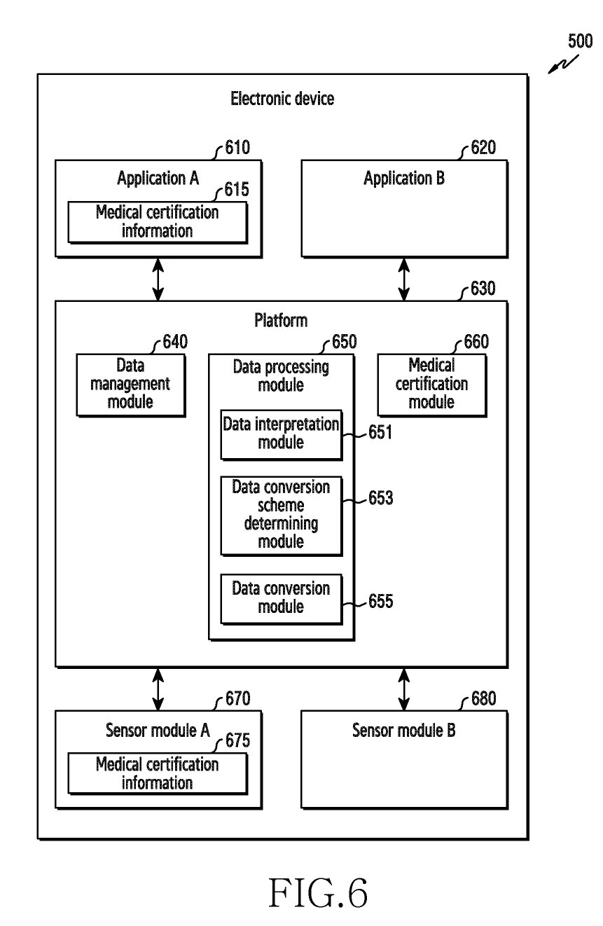

FIG. 6 illustrates an example of a program module for processing health data in an electronic device according to various embodiments of the present disclosure.

Referring to FIG. 6, according to various embodiments, the electronic device 500 includes, for example, an application A 610 (e.g., a medical application) including medical certification information 615, an application B 620 (e.g., a non-medical application) not including the medical certification information, a sensor module A 670 (e.g., a medical sensor module) including medical certification information 675, a sensor module B 680 (e.g., a non-medical sensor module) not including the medical certification information, and a platform 630 for processing health data depending on whether it is medically certified.

According to various embodiments, the platform 630 may include a set of modules to provide transmitting, certifying, processing, storing or the like of data through a path such as an Application Programming Interface (API) so as to utilize a hardware or software function of the electronic device 500. For example, the platform 630 may include a function of the program module 310 of FIG. 3, and an example of a health related program module may be shown in FIG. 6.

According to various embodiments, the platform 630 may include a data management module 640, a data processing module 650, and a medical certification module 660.

In various embodiments, a process performed by the data management module 640 may include acquiring, delivering, storing, or the like of health data and/or control data. For example, the data management module 640 may receive a request of data which intends to have access to an application (e.g., the application 370 of FIG. 3) through an API (e.g., the API 145 or 360) or the like, and may deliver control data to a sensor to which the application intends to have access through the API or the like.

In various embodiments, a process performed by the data processing module 650 may include interpreting, translating, or the like of health data and/or control data. According to the various embodiments, as at least one part of the function, the data processing module 650 may be configured by including a data interpretation module 651, a data translation scheme determining module 653, a data translation module 655, or the like.

According to various embodiments, the data interpretation module 651 may generate interpreted data by using raw data (or unprocessed data) included in health data and/or control data. The data interpretation module 651 may use an equation, a statistics, an algorithm, a table, or the like for creating meaningful data according to a data type.

According to various embodiments, the data translation module 655 may perform data translation in various manners by using the determined processing method related to the medical certification through the data translation scheme determining module 653, as to health data and/or control data. According to one embodiment, the data translation module 655 may include a processing method for reducing or preventing data from being delivered to a target by including information more than necessary in a module for providing data. In the various embodiments, the data processing method may include the method exemplified in Table 1, and Table 2 below shows an example of processing blood pressure data, for example, according to whether a target to which the blood pressure data is delivered is a medical application or a non-medical application.

TABLE 2
Type Of Data Processing Method
Coaching
Simplifying
Categorizing
Abstracting
Deleting

Referring to Table 2 and Table 3, in various embodiments, the data processing method may include a processing method such as coaching, simplifying, categorizing, abstracting, deleting, or the like. According to the various embodiments, the health data may be provided differently through data processing on the basis of a medical application (or a medical electronic device) or a non-medical application (or a non-medical electronic device).

According to one embodiment, the coaching-processing method may include a method of changing information of a medical opinion level into a normal recommendation form. For example, if a target is a medical application, detailed information such as “You have an early stage of high blood pressure” may be provided, and if the target is a non-medical application, “You have an early stage of high blood pressure.” may be provided by being processed into data with coaching such as “A cardiovascular consultation is recommended.”.

According to one embodiment, the simplifying-processing method may include a method of simplifying and providing a detailed numeric value and/or graph. For example, if the target is a non-medical application, data may be provided by being processed in a manner of truncating below decimal point, truncating down certain decimal places, replacing with a mean value, or the like. Alternatively, if the target is a medical application, graph data may be provided as a detailed graph, and if the target is a non-medical application, the graph data may be provided by being processed in a discontinuous or stepwise manner or the like.

In various embodiments, the categorizing-processing method may include a method in which a precise numeric value is processed by further including any range in an upper and/or lower direction. For example, if the target is the medical application, a precise numeric value may be provided such as “systolic blood pressure: 150”, and if the target is the non-medical application, “systolic blood pressure: 150” may be provided by being processed into range data such as “systolic blood pressure: in the range about 140 to 160”.

In various embodiments, the abstracting-processing method may include a method of providing only a specific part instead of a whole numeric value or graph. For example, if the target is the medical application, a whole numeric value or graph may be provided such as “systolic blood pressure: 150, diastolic blood pressure: 100”, and if the target is the non-medical application, “systolic blood pressure: 150, diastolic blood pressure: 100” may be provided by being processed to include only specific information such as “high duration is present”.

In various embodiments, the deleting-processing method may include a method of deleting a part of data. For example, if the target is the medical application, both of blood pressure information and heart rate information included in health data may be provided, and if the target is the non-medical application, the information may be provided by deleting a part of information (e.g., blood pressure information) from the blood pressure information and heart rate information included in the health data.

According to various embodiments, the data translation scheme determining module 653 may analyze several factors to determine a translation scheme to be used in the data translation module 655. In the various embodiments, the data translation scheme determining module 653 may include various factors decided to determine a data processing method as shown in the example of Table 4 below.

TABLE 4

| Provided target | Certification type | Usage purpose |
|---|---|---|
| Application | (US-FDA) Class I, II, III | Coaching |
| Platform | (KOREA-safety management | Medicine |
| | guideline for a mobile | |
| | medical app) | |
| | Managed classification of medical | |
| | devices | |
| Sensor | (EP-EFTA) | Individual |
| | Class I (including Is & Im), Ila, IIb, III | |
| Database | | Research |
| | | Statistic |

Table 4 shows an example of factors decided to determine the data processing method. A provided target item may indicate a type (e.g., an application, a platform, a sensor, a database, etc.) of a target for receiving data. A certification type item may indicate whether the target for receiving the data is medically certified, and indicates a type of medical certification (e.g., FDA, a safety management guideline for a mobile medical app, or a certification type based on a classification criterion designated in certification authority of each country such as EFTA or the like). A usage purpose item may indicate a usage (e.g., coaching, medicine, individual, research, statistic, etc.) on the basis of which the target for receiving the data uses the data.

According to one embodiment, in order to determine a data processing method, an electronic device may decide a type of a target for receiving data, may decide whether the target for receiving the data is medically certified and a type of the medical certification, may decide a purpose on the basis of which the target for receiving the data uses the data, or may decide a combination of those conditions. The electronic device may determine the data processing method on the basis of a result of the decision. For example, it may be determined that different data processing methods are used in a case where the target for receiving the data is an application and a case where the target is a platform. For another example, even if the target for receiving the data is medically certified, it may be determined to use a different data processing method according to a type of the medical certification. For another example, if a purpose of using data of the target for receiving the data is coaching, a method such as coaching or abstracting or the like may be used, or if the purpose of using the data of the target for receiving the data is medicine or research, it may be determined that detailed data is not additionally processed.

In various embodiments, the medical certification module 660 may request and receive medical certification information as to the electronic device or the application, and thus may decide whether it is medically certified. The medical certification module 660 may determine whether the electronic device is a medical electronic device or a non-medical electronic device according to whether it is medically certified. In the various embodiments, the medical certification module 660 may decide whether to perform medical certification on a target for receiving data, in order to reduce or prevent data delivered by the data management module 640 from being delivered to the non-medical electronic device or the non-medical application in a state of including information more than necessary. The medical certification module 660 may perform determining and processing of a data processing method through the data processing module 650 according to whether it is medically certified.

In various embodiments, the medical certification information 615 and 675 may include information including medical certification content of the electronic device or the application. For example, the medical certification information 615 and 675 may include information such as whether it is medically certified, a medical certification agency, a certification date, an expiry date, a version, a level, a usage, etc., or connection information (e.g., URL, IP, etc.) as to a server or a device or the like capable of having access to information equivalent thereto.

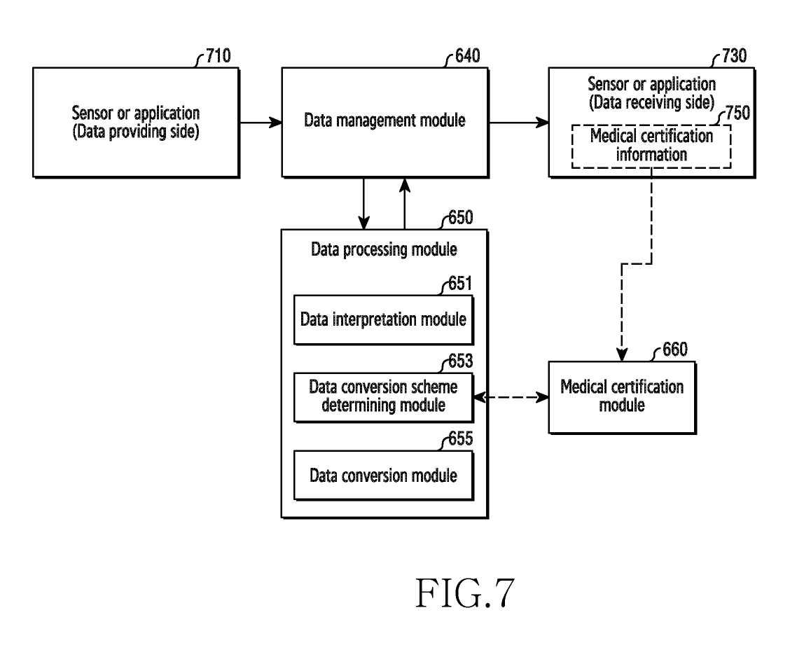

FIG. 7 illustrates an example of an operation for processing health data in an electronic device according to various embodiments of the present disclosure.

Referring to FIG. 7, upon receiving health data from a first object (e.g., including a sensor or application 710 for providing data, or a different external device), the data management module 640 may deliver the received health data to a second object (e.g., a sensor or application 730 of a different device for receiving data). According to various embodiments, upon receiving health data from the first object 710, the data management module 640 may decide a target to which the health data is to be delivered. In the various embodiments, a data delivery target, for example, the second object 730, may include a different sensor, a different application, or a different external device.

The medical certification module 660 may decide whether an entity (e.g., the second object 730) for receiving the health data has medical certification information 750. According to one embodiment, the medical certification module 660 may request the second object 730 which is a data delivery target to provide the medical certification information 750, and may receive a response (e.g., the medical certification information 750 or a negative response) for the request from the second object 730. According to various embodiments, in response to the request of the medical certification module 660, the second object 730 may deliver the medical certification information 750 to the medical certification module 660 if the medical certification information 750 is included, and may deliver a negative response to the medical certification module 660 if the medical certification information is not included.

Upon receiving the medical certification information 750 from the second object 730 according to the response from the second object 730, that is, upon deciding that the second object 730 is an object which is medically certified, the medical certification module 660 may examine a validity for the received medical certification information 750. According to various embodiments, the medical certification module 660 may deliver a result for the response from the second object 730. For example, the medical certification module 660 may deliver whether the negative response or the received medical certification information 750 is valid.

According to various embodiments, a specific field (e.g., a medical field) of data to be delivered may be used to examine whether the data to be delivered is medical data (e.g., health data) or non-medical data (e.g., normal data). According to one embodiment, if the data to be delivered is not the medical data, that is, if it is the non-medical data, an operation of requesting the data delivery target to provide the medical certification information in the medical certification module 660 may be omitted. For example, in the various embodiments, if it is decided that the data to be delivered is the medical data, an operation of requesting and receiving the medical certification information with respect to the data delivery target may be performed.

The data management module 640 may decide a type of the second object 730 which is the data delivery target on the basis of a result delivered from the medical certification module 660. According to one embodiment, upon deciding that medical certification information is not present for the second object 730, or upon deciding that a validity thereof is lost even if the medical certification information 750 is present, the data management module 640 may recognize the second object 730 as a non-medical electronic device (or a non-medical sensor or application). In this case, if health data is delivered directly to the second object 730, it may be against a constraint (e.g., HIPPA policy rule or the like). Accordingly, in various embodiments, a process for the health data may be performed through the data processing module 650.

The data processing module 650 may use the data translation scheme determining module 653 to determine a proper health data translation scheme as described above with reference to Table 4. Additionally or alternatively, in various embodiments, even if the second object 730 is the medical electronic device or the medical application, it may be decided whether it is an object with a level capable of handling (or using) health data to be delivered by the second object 730, and if a result thereof shows that the condition is not satisfied, the health data may be provided through translation.

When the data translation scheme is determined through the data translation scheme determining module 653, the data processing module 650 may use the data translation module 655 to translate the health data by applying the determined method.

As to health data or control data, the data translation module 655 may perform various processes as described above by using a method determined in association with a medical certification through the data translation scheme determining module 653. In various embodiments, the data translation module 655 may include a processing method for reducing or preventing data from being delivered to the second object 730 by including information more than necessary in a module for providing data. For example, as described above with reference to Table 2 and Table 3, data translation may be performed on the basis of at least one of various processing methods. In one embodiment, if data to be delivered to the second object 730 is blood pressure data, according to whether the second object 730 is a medical application or a non-medical application, data translation may be processed on the basis of at least one of coaching, simplifying, categorizing, abstracting, and deleting.

If the health data needs to be interpreted, the data processing module 650 may perform a data interpretation operation on the basis of the data interpretation module 651, and may translate the data into meaningful data. For example, if the health data to be delivered is raw data (e.g., unprocessed data, signals, waveforms, or the like which is read through a sensor), additional data (e.g., interpreted data) may be generated by interpreting the data such that the data is meaningfully used by a specific module or user. According to one embodiment, interpreted data to be interpreted by the data interpretation module 651 may include various types of data such as a value, a statistics (e.g., a maximum, a minimum, a mean, a mode, a deviation, etc.), a graph, a diagnosis, a classification, a recommendation, a coaching, or the like. For example, even if the data to be delivered is the interpreted data, the data processing module 650 may derive new interpreted data from a set of interpreted data and may allow the data to be included in health data in order to deliver it with a higher level service. According to one embodiment, diagnosis information, prescription information, or the like may be included.

The data management module 640 may deliver health data processed through the data processing module 650 to a data delivery target (e.g., the second object 730).

According to one embodiment, if the second object 730 is the medical application, health data including detailed information (e.g., medical level) which is not additionally translated may be delivered to the second object 730. Therefore, the second object 730 may display information of the medical level.

According to another embodiment, if the second object 730 is the non-medical application, health data translated using at least one translation scheme may be delivered to the second object 730. Therefore, the second object 730 cannot display the information of the medical level, and thus may display much simpler or another type of information.

According to another embodiment, the second object 730 may be an application in a form of a dashboard (e.g., a UI function by which a variety of information is managed in a centralized manner and is discovered in one screen) which displays data provided from several applications. In this case, according to whether an application which is a source of data is a medical application or a non-medical application, detailed information (e.g., whether it is for a medical purpose) of data which can be displayed may be provided differently.

As described above, modules according to various embodiments of the present disclosure may be provided in a form of an API (e.g., the API 145 of FIG. 1, the API 360 of FIG. 3) provided in a platform, may include an application (e.g., the application 147 of FIG. 1, the application 370 of FIG. 3), or may be implemented in a hardware manner (e.g., the certification processor 585 of FIG. 5).

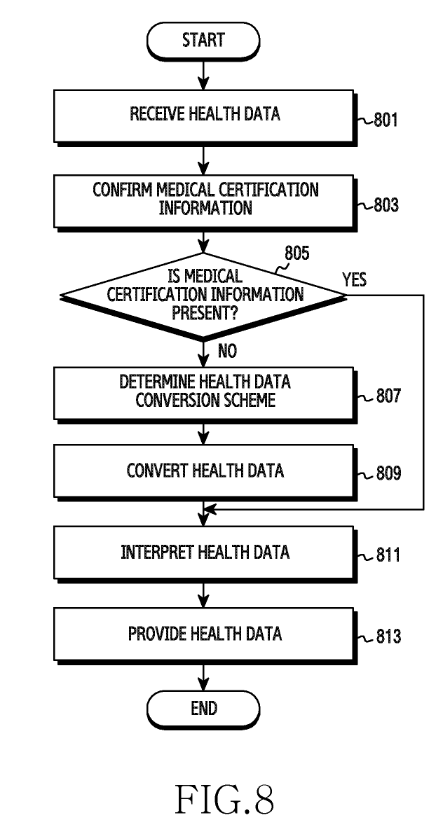

FIG. 8 is a flowchart illustrating a method of operating an electronic device according to various embodiments of the present disclosure.

Referring to FIG. 8, in operation 801, the controller 580 (e.g., the processor, the control circuit) of the electronic device 500 may receive health data. For example, the controller 580 may receive sensing information related to user's body or bio information from the sensor module 575 of the electronic device 500 or an external electronic device (e.g., a wearable device) connected to the electronic device 500. According to various embodiments, the controller 580 may perform an operation of acquiring health data in response to a health data request of a user of the electronic device 500 from at least one object (e.g., an application of the electronic device 500, or a different external electronic device or an application thereof). In the various embodiments, the object may include at least one different sensor or different application configured to collect the health data.

The controller 580 may confirm medical certification information in operation 803, and may decide whether a data delivery target includes the medical certification information. According to various embodiments, the controller 580 may decide an object for delivering the health data (e.g., a target for receiving the health data), and may decide medical certification information of the decided object. For example, the controller 580 may decide the data delivery target, that is, the object, in response to reception of the health data, and may decide whether the object has the medical certification information. According to the various embodiments, the controller 580 may request and receive a medical certification request through mutual communication with the object. According to the various embodiments, if the object includes the medical certification information, that is, if the medical certification information is received from the object, the controller 580 may examine validity regarding the received medical certification information. In the various embodiments, if the object is not a medical object, the controller 580 may skip operations 803 and 805 related to the requesting of the medical certification information to the object.

In operation 805, upon deciding that the object includes the medical certification information (“yes” in operation 805), proceeding to operation 811, the controller 580 may perform operations subsequent to operation 811.

In operation 805, upon deciding that the object does not include the medical certification information (“no” in operation 805), the controller 580 may determine a health data translation scheme in operation 807. According to various embodiments, if it is determined that the received medical certification information is invalid as a result of examining the validity of the received medical certification information, the controller 580 may perform an operation which is the same as or similar to a case where the object of the operation 805 does not include the medical certification information. According to the various embodiments, upon deciding that the object does not have the medical certification information or that the medical certification information is invalid, the controller 580 may decide the object as a non-medical device or a non-medical application. Upon deciding the object as the non-medical device or the non-medical application, the controller 580 may determine to change data to be delivered to the object, and may determine a proper translation scheme (e.g., a first translation scheme, a second translation scheme, etc.) to translate data on the basis of at least one of an object type, a certification type, a usage purpose, and the like as described above with reference to Table 1 to Table 3.

In operation 809, the controller 580 may translate the health data on the basis of the determined data translation scheme. For example, the controller 580 may translate at least one part of the received health data to generate translated health data. The controller 580 may perform data translation in various manners by using the determined translation scheme related to the medical certification.

In operation 811, the controller 580 may interpret the health data (e.g., the translated health data, the received health data). According to various embodiments, as described above with reference to Table 1 to Table 3, the controller 580 may process raw data (e.g., unprocessed data) and may generate interpreted data by interpreting the data in various forms, for example, a value, a statistics (e.g., a maximum, a minimum, a mean, a mode, a deviation, etc.), a graph, a diagnosis, a recommendation, a coating, or the like, so as to be used by an object or a user. According to the various embodiments, the controller 580 may decide whether there is a need to interpret the translated health data, and if the data interpretation is necessary, may translate the translated health data as meaningful data. According to the various embodiments, in order to deliver the interpreted data with a higher level service, the controller 580 may further include new interpreted data (e.g., diagnosis information, prescription information, etc.) on the basis of the interpreted data.

In operation 813, the controller 580 may provide the health data (e.g., the interpreted data) to the object. According to various embodiments, the controller 580 may provide control to deliver the health data to the object, or to output the health data through the object. According to one embodiment, if the object is a medical application, the controller 580 may provide control such that health data including detailed information and not subjected to data translation is displayed by delivering it to the object. According to one embodiment, if the object is a non-medical application, the controller 580 may provide control such that health data including simple information and subjected to data translation is displayed by delivering it to the object. According to another embodiment, if the object is a dashboard-type application, information of health data (e.g., whether it is for a medical purpose) to be displayed may be provided differently depending on whether a final object which intends to use the health data is for a medical purpose or a non-medical purpose.

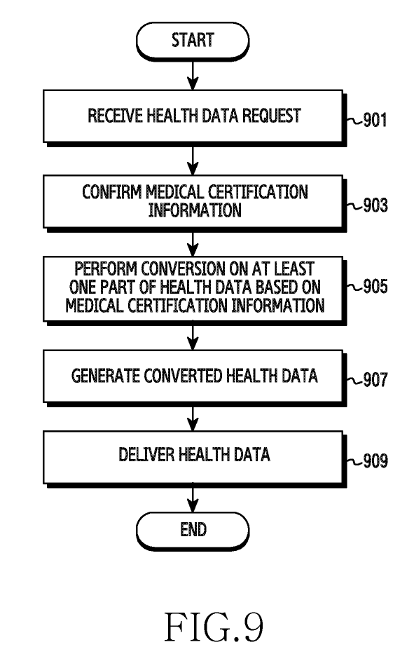

FIG. 9 is a flowchart illustrating a method of operating an electronic device according to various embodiments of the present disclosure.

Referring to FIG. 9, in operation 901, the controller 580 (e.g., the processor, the control circuit) of the electronic device 500 may receive a health data request. According to various embodiments, the controller 580 may detect a request for health data of a user from at least one object (e.g., a different electronic device, a sensor, an application, etc.) configured to collect the health data of the electronic device 500.

In operation 903, the controller 580 may confirm medical certification information. For example, the controller 580 may confirm medical certification information corresponding to at least one object, and may decide whether the object includes the medical certification information or whether the medical certification information included in the object is valid (e.g., a validity check) or the like.

In operation 905, the controller 580 may translate the health data. According to various embodiments, the controller 580 translates at least one part of the health data on the basis of the medical certification information corresponding to the object. According to the various embodiments, the health data may be data including at least one part of sensing information collected from a sensor (e.g., the sensor module 575) of the electronic device 500 or an external device (e.g., a wearable device) operatively connected to the electronic device 500.

In operation 907, the controller 580 may generate health data translated based on data translation. According to various embodiments, the controller 580 may generate health data translated based on at least one of the aforementioned operations 807, 809, and 811 of FIG. 8.

In operation 909, the controller 580 may deliver the translated health data to at least one object which requests for the health data. According to various embodiments, the controller 580 may deliver different health data depending on at least one object (e.g., a medical application or a non-medical application). According to the various embodiments, the controller 580 may deliver the data by including a control instruction (e.g., control data, medical control data) related to controlling of health data output by at least one object.

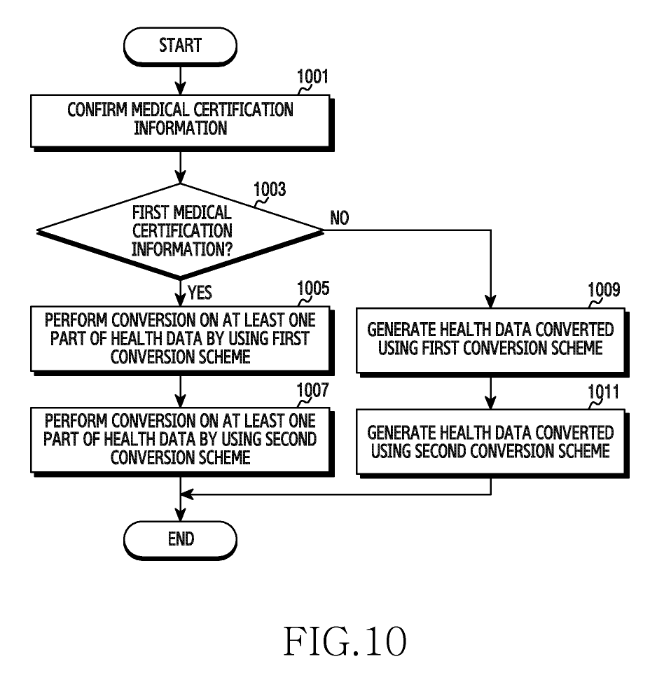

FIG. 10 is a flowchart illustrating a method of operating an electronic device according to various embodiments of the present disclosure.

Referring to FIG. 10, in operation 1001, the controller 580 (e.g., the processor, the control circuit) of the electronic device 500 may decide medical certification information corresponding to at least one object. For example, the controller 580 may confirm the medical certification information corresponding to the at least one object configured to collect health data of the electronic device 500. According to various embodiments, the controller 580 may decide whether the at least one object includes the medical certification information or whether the medical certification information included in the at least one object is valid (e.g., a validity check) or the like.

In operation 1003, the controller 580 may decide whether the medical certification information corresponds to first medical certification information or second medical certification information on the basis of a result of the decision. In various embodiments, the controller 580 may request the at least one object to provide the medical certification information, and may decide the first medical certification information or the second medical certification information according to whether the certification information is received in response to the request. According to one embodiment, the first medical certification information may indicate information for a case where the at least one object includes the medical certification information or where the received medical certification information is decided to be valid through the decision of validity. According to one embodiment, the second medical certification information may indicate information for a case where the at least one object does not include the medical certification information or where the received medical certification information is decided to be invalid through the decision of validity.

In operation 1003, if it is decided that the medical certification information corresponds to the first medical certification information (“yes” in operation 1003), the controller 580 may perform data translation on at least one part of the health data by using a first translation scheme. According to various embodiments, the first translation scheme may include a scheme of performing translation in association with a health data usage (purpose) of an object corresponding to the first medical certification information. For example, the health data may include data (information) in a wider (greater) range than a range of data provided to the object, and the controller 580 may translate at least one part of the data (information) by using the first translation scheme. For example, the controller 580 may process raw data to translate it into health data including related detailed information so that the object can use the health data according to a usage, or may additionally translate it into health data further including additional information (e.g., diagnosis information, prescription information, etc.) on the basis of the raw data.

In operation 1007, the controller 580 may generate health data translated by using the first translation scheme (e.g., a scheme of performing translation so that detailed information and/or additional information is included).

If it is decided in operation 1003 that the medical certification information corresponds to the second medical certification information (“no” in operation 1003), the controller 580 may perform data translation on at least one part of the health data by using a second translation scheme in operation 1009. According to various embodiments, the second translation scheme may include a scheme of performing translation in association with a health data usage (purpose) of an object corresponding to the second medical certification information. For example, the health data may include data (information) in a wider (greater) range than a range of data provided to the object, and the controller 580 may translate at least one part of the data (information) by using the second translation scheme. For example, the controller 580 may process raw data to translate it into health data including related simple information so that the object can use the health data according to a usage.

In operation 1011, the controller 580 may generate health data translated by using the second translation scheme (e.g., a scheme of performing translation so that simply information is included).

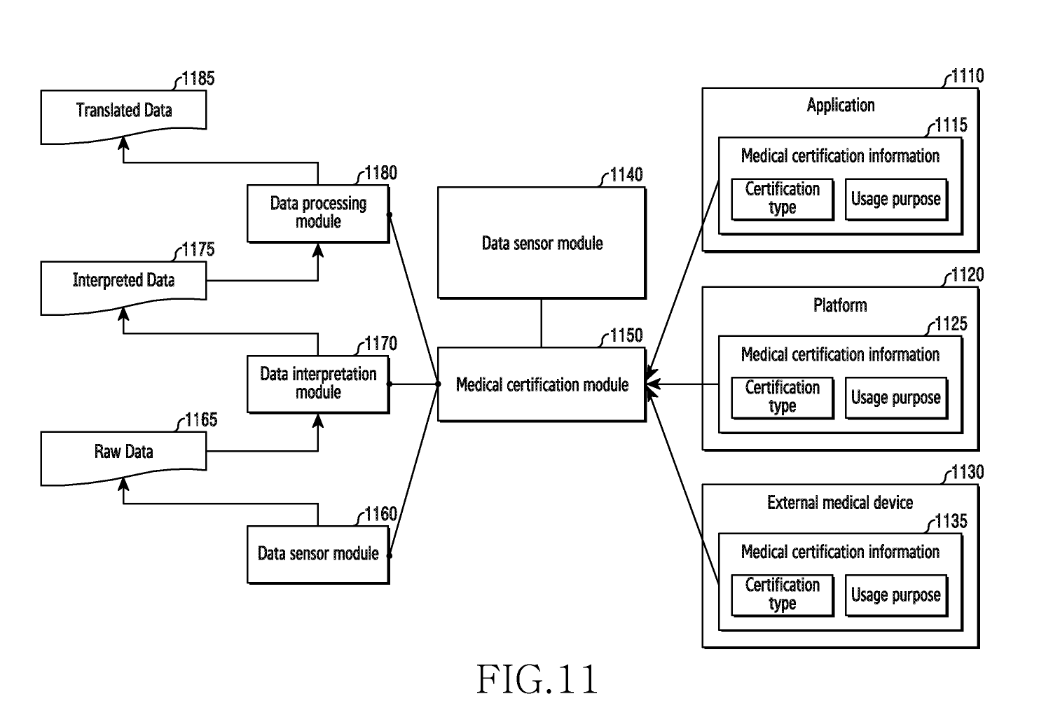

FIG. 11 illustrates a series of operations of an electronic device according to various embodiments of the present disclosure.

Referring to FIG. 11, according to various embodiments, the electronic device 500 may receive a request for user's health data from various objects (e.g., an application 1110, a platform 1120, an external medical device 1130, etc.) configured to collect the health data.

According to various embodiments, the various objects 1110, 1120, and 1130 may respectively include medical certification information 1115, 1125, and 1135. According to the various embodiments, the medical certification information 1115, 1125, and 1135 may include a variety of information related to medical certification content of a corresponding object, for example, at least one of a certification type, a usage purpose, a medical certification agency, a certification date, an expiry date, a version, a level, and the like.

According to various embodiments, upon receiving a request for health data from at least one of the objects 1110, 1120, and 1130, the electronic device 500 may decide whether a corresponding object is medically certified through a medical certification module 1150. According to one embodiment, the medical certification module 1150 may decide whether the objects 1110, 1120, and 1130 which request for the health data include medical certification information, and on the basis of a result of the decision, may decide whether the corresponding object is medically certified.

According to various embodiments, the electronic device 500 may process data translation corresponding to a corresponding object depending on whether the objects 1110, 1120, and 1130 which are data delivery targets are medical objects or non-medical objects through a data processing module 1180, on the basis of a certification result of the medical certification module 1150. According to one embodiment, the electronic device 500 may decide whether the objects 1110, 1120, and 1130 are the medical objects or the non-medical objects on the basis of the certification result of the medical certification module 1150. According to one embodiment, the data translation module 1140 may determine a data processing method depending on a type or usage purpose of the objects 1110, 1120, and 1130 which are the data delivery targets.

According to various embodiments, the electronic device 500 may process data translation through the data translation module 1140 on the basis of at least one of various data translation schemes. According to one embodiment, the data translation module 1140 may translate data into medical data including detailed information or non-medical data including simple information on the basis of the determined data translation scheme. For example, the electronic device 500 may perform data translation by using raw data 1165 (e.g., unprocessed data, signals, waveforms, or the like which is read through a sensor module 1160) collected from the sensor module 1160. According to the various embodiments, the raw data 1165 may include data in a wider (greater) range than a range included in data based on the data translation.

According to various embodiments, if the raw data 1165 requires an interpretation, the electronic device 500 may interpret the raw data 1165 through a data interpretation module 1170, and may translate it into meaningful data. According to one embodiment, the data interpretation module 1170 may interpret the raw data 1165 and may generate it into interpreted data 1175. According to the various embodiments, the interpreted data 1175 may be translated into various types of data such as a value, a statistics (e.g., a maximum, a minimum, a mean, a mode, a deviation, etc.), a graph, a diagnosis, a classification, a recommendation, a coaching, or the like. According to the various embodiments, even if data to be delivered is the interpreted data 1175 the electronic device 500 may generate new interpreted data from the interpreted data 1175 in order to deliver the data with a higher level service.

According to various embodiments, the electronic device 500 may process data translation on the basis of the raw data 1165 or the interpreted data 1175, and may generate final data (e.g., translated data 1185) to be delivered to the objects 1110, 1120, and 1130. According to the various embodiments, the electronic device 500 may use the data processing module 1180 to determine whether to perform data translation depending on whether the objects 1110, 1120, and 1130 are medical objects or non-medical objects.

According to one embodiment, if at least one of the objects 1110, 1120, and 1130 is the medical object, data translated to conform to a type and/or a usage purpose of a corresponding object may be provided for the object by including detailed information (e.g., a medical level). According to one embodiment, if at least one different object among the objects 1110, 1120, and 1130 is the non-medical object, data translated to conform to a type and/or a usage purpose of a corresponding object may be provided for the object by including simple information.

As described above, a method of operating the electronic device 500 according to various embodiments of the present disclosure may include receiving a request for health data of a user from at least one object configured to collect the health data, confirming medical certification information corresponding to the at least one object, generating translated health data by performing translation on at least one part of the health data on the basis of at least the medical certification information, and delivering the translated health data to the at least one object.

According to various embodiments, the at least one object may include an application, sensor, or different electronic device configured to collect the health data.

According to various embodiments, the generating may include generating the translated health data from at least one part of the health data by using a first translation scheme if the medical certification information corresponds to first medical certification information, and generating the translated health data from the at least one part of the health data if the medical certification information corresponds to second medical certification information.

According to various embodiments, the generating may include confirming a health data usage of the at least one object on the basis of the medical certification information, and performing the translation on the basis that the health data includes data in a wider range than a range of data corresponding to the usage.

According to various embodiments, the health data may be configured to include health data acquired from an object different from the at least one object.

According to various embodiments, the receiving of the request may include acquiring the health data by using a sensor different from the at least one object in response to the request.

According to various embodiments, the receiving of the request may include acquiring the health data from an application different from the at least one object in response to the request.

According to various embodiments, the receiving of the request may include requesting a different electronic device to provide the health data in response to the request.

According to various embodiments, the confirming may include confirming medical certification information stored in the electronic device, and confirming medical certification information stored in the external electronic device.

According to various embodiments, the performing of the translation may include performing the translation on at least one part of the health data by using at least one translation scheme among simplifying, categorizing, abstracting, and deleting.

According to various embodiments, the method of operating the electronic device 500 may include selecting a source of health data corresponding to an item configured to display health information, deciding medical certification information corresponding to the source, displaying a certification identifier in association with the item on the basis of the medical certification information, and displaying the health data in association with the item.

According to various embodiments, the displaying may include providing the health data on the basis of detailed medical information in response to a selection of an application which is medically certified, and providing the health data on the basis of simple medical information in response to a selection of an application which is not medically certified

According to various embodiments, the displaying may include providing the health data on the basis of detailed medical information upon selection of the application which is medically certified, and providing the health data on the basis of simple medical information upon selection of the application which is not medically certified.

According to various embodiments, the providing based on the simple medical information may include providing the simple medical information by using at least one translation scheme among simplifying, categorizing, abstracting, and deleting.

According to various embodiments, the displaying may include deciding whether the selected application is medically certified in response to the selection of the application, and displaying medical certification information in association with the selected application on the basis of a result of the decision.

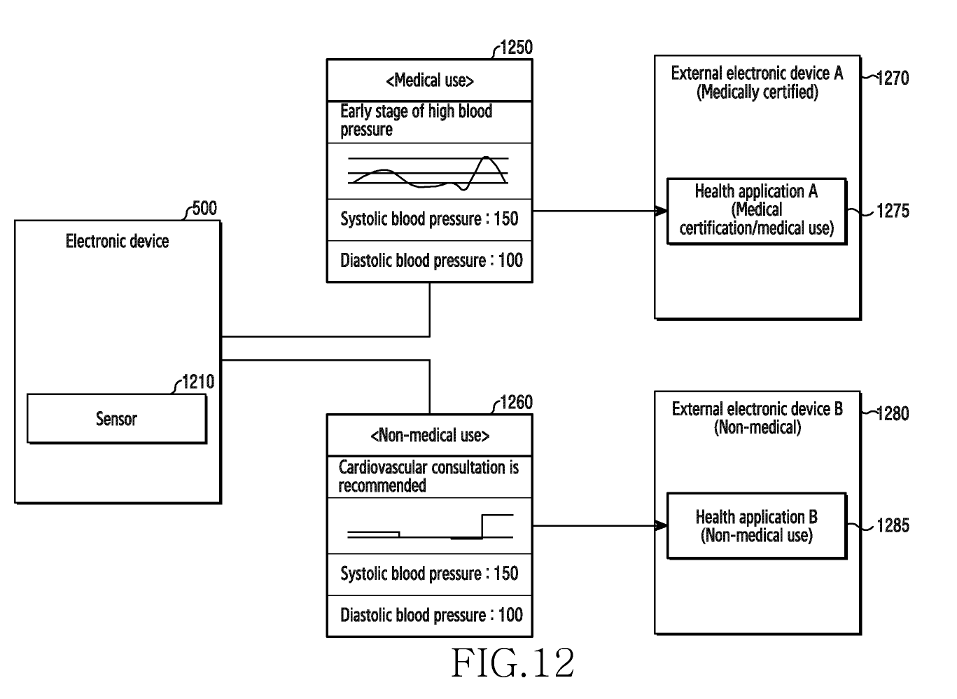

FIG. 12 illustrates an operation of providing data in an electronic device according to various embodiments of the present disclosure.

As shown in FIG. 12, according to various embodiments, the electronic device 500 may transmit health data in a data processing state as little as required for a service and/or a usage purpose or the like that can be provided by a target object (e.g., an external electronic device A 1270, an external electronic device B 1280) to which health data is delivered.

According to various embodiments, when the electronic device 500 transmits health data acquired through a sensor 1210 to an external electronic device (e.g., the external electronic device A 1270, the external electronic device B 1280), a detailed level of the health data to be delivered may be provided differently depending on whether the external electronic devices 1270 and 1280 (or an application (e.g., a health application A 1275, a health application B 1285) executed in the external electronic device) are medically certified.

According to one embodiment, a case where the external electronic device A 1270 or the health application A 1275 executed in the external electronic device A 1270 is a medically certified or is a medical electronic device (or application) is shown in FIG. 12, and the external electronic device B 1280 or the health application A 1275 executed in the external electronic device B 1280 is not medically certified or is a non-medical electronic device (or application).

Referring to FIG. 12, the electronic device 500 may request and receive medical certification information as to the external electronic devices 1270 and 1280. According to various embodiments, the external electronic devices 1270 and 1280 may transmit medical certification information or a negative response to the electronic device 500 in response to the request of the electronic device 500 (e.g., a medical certification module). According to the various embodiments, the electronic device 500 may decide whether the external electronic device is medically certified through the medical certification module on the basis of at least one part of the received medical certification information (or the negative response).

According to various embodiments, the electronic device 500 may determine a translation scheme for data to be delivered to the external electronic devices 1270 and 1280 depending on whether the external electronic devices 1270 and 1280 are medically certified. The electronic device 500 may translate health data in response to the determined translation scheme. According to one embodiment, the electronic device 500 may translate health data to be delivered to the external electronic device A 1270 (or the health application A 1275 executed in the external electronic device A 1270) into medical data including detailed information as indicated by a reference numeral 1250. According to one embodiment, the electronic device 500 may translate health data to be delivered to the external electronic device B 1280 (or the health application B 1285 executed in the external electronic device B 1280) into non-medical data including simple information as indicated by a reference numeral 1260.

According to various embodiments, the electronic device 500 may transmit the translated health data to the external electronic devices 1270 and 1280. According to one embodiment, if a data delivery target is the external electronic device A 1270 which is medically certified, the electronic device 500 may transmit the health data translated into the medical data 1250 including the detailed information. According to one embodiment, if the data delivery target is the external electronic device B 1280 which is not medically certified, the electronic device 500 may transmit health data translated into the non-medical data 1260 including simple information.

According to various embodiments, medical certification information regarding an object (e.g., a sensor, an application, an external electronic device, etc.) for frequently transmitting health data may be stored in the electronic device 500 after the information is initially requested and received, and the electronic device 500 may operate in reference to the information in a situation where certification is necessary. According to the various embodiments, the medical certification information stored in the electronic device 500 may be deleted when it is not used more than a specific time (e.g., in unit of time, day, week, month, etc.). According to the various embodiments, the electronic device 500 may operate to update the medical certification information depending on a determined period as to an object which has never delivered the health data more than a specific time (or duration). According to one embodiment, when the electronic device 500 checks the stored medical certification information to detect an update period, the stored medical certification information may be updated through mutual communication (e.g., update request and reception) with respect to an object of the medical certification information.

According to various embodiments, the electronic device 500 may process control data for controlling the external electronic device (e.g., the external electronic device A 1270 and the external electronic device B 1280) and may deliver it to the external electronic device. For example, the electronic device 500 for controlling the external electronic device or an application executed in the electronic device 500 may also be a target of a medical certification.

In various embodiments, when the external electronic device (e.g., the medical external electronic device) is controlled from the electronic device 500 (or application), if the electronic device 500 (or application) is not medically certified, a function which requires the medical certification may be restricted among functions of the external electronic device. According to one embodiment, whether the electronic device 500 is medically certified is decided and data processing for control data may be performed on data for controlling the external electronic device.

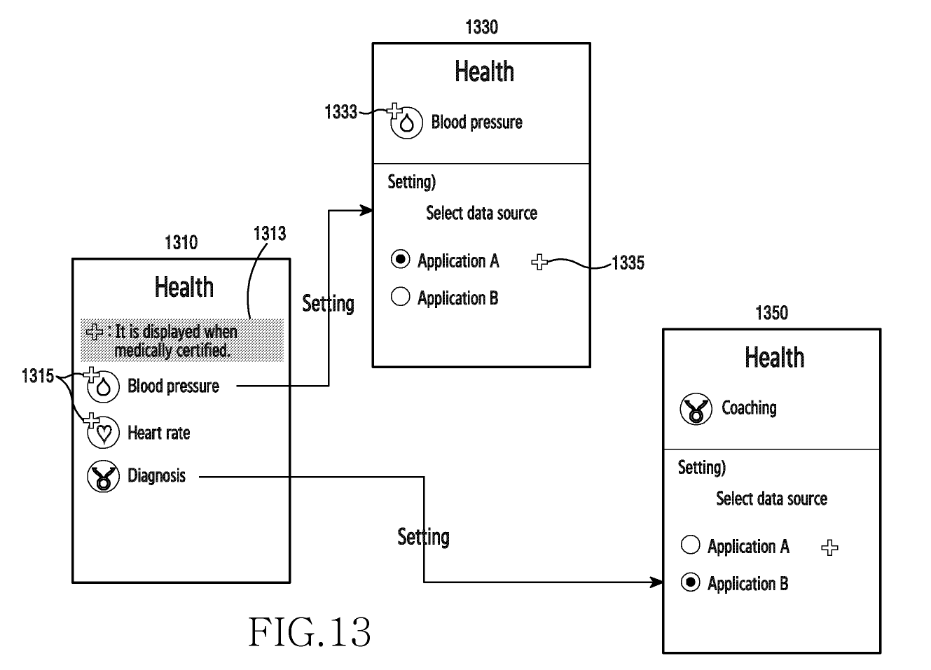

FIG. 13 illustrates an example of a screen which outputs health data in an electronic device according to various embodiments of the present disclosure.

Referring to FIG. 13, according to various embodiments, an example of a screen 1310 may show a list screen (e.g., a list page) of health applications. As shown in the screen 1310, the list screen may provide a guidance message 1313 for defining a certification identifier 1315 (e.g., a green cross mark). For example, together with an icon shape (e.g., a green cross shape) corresponding to the certification identifier 1315, a guidance (e.g., ‘It is displayed when medically certified’) may be provided to indicate that a corresponding icon is output when it is medically certified.

According to one embodiment, the screen 1310 may show an example of a screen for collecting and providing processed health data from a medical application or a non-medical application. For example, as shown in the screen 1310, an application provided in the list screen may include a medical application (e.g., blood pressure, heart rate) which is medically certified and a non-medical application (e.g., diagnosis) which is not medically certified. According to various embodiments, a user may select a sensor or application which is a source of corresponding health data as to a variety of health data that can be provided through the electronic device 500. According to the various embodiments, a health related application or sensor may be installed and used by the user.

In various embodiments, the electronic device 500 may provide a certification identifier according to whether an object is medically certified. For example, as shown in the example of the screen 1310, the electronic device 500 may provide the certification identifier 1315 together with information of a corresponding application among health applications (e.g., blood pressure, heart rate, diagnosis, etc.) executed in the electronic device 500. According to one embodiment, the certification identifier 1315 may be provided in an area overlapping with or adjacent to an icon for indicating the application. According to the various embodiments, as shown in the example of the screen 1310, medical certification may also be performed (requested) for an application constituting the list screen (e.g., an integral application in a dashboard shape) depending on whether data to be delivered is for a medical purpose or a non-medical purpose.

In various embodiments, if data is processed according to whether the health application is medically certified, a type of the health data may be changed through data processing. For example, a service name, category, icon, or the like corresponding to the changed data type may be changed and provided.

The user may configure health applications by selecting a specific item in the list screen as shown in the example of the screen 1310. For example, as shown in the screen 1310, an application to be used as a source of health related data may be selected for each function such as blood pressure, heart rate, diagnosis, or the like. According to one embodiment, if a blood pressure application item is selected in the screen 1310, as shown in a screen 1330 for example, a screen (e.g., a configuration page) capable of selecting a data source from the blood pressure application may be provided. According to another embodiment, if a diagnosis application item is selected in the screen 1310, as shown in a screen 1350 for example, a screen (e.g., a configuration page) capable of selecting a data source from a diagnosis application may be provided.

According to various embodiments, the electronic device 500 may decide whether the selected application (e.g., the blood pressure application, the diagnosis application) is medically certified. According to one embodiment, if the selected application is a medically-certified application, the electronic device 500 may provide a certification identifier 1333 related to a medical certification as shown in the example of the screen 1330. According to another embodiment, if the selected application is a non-medical application which is not medically certified, the electronic device 500 may not provide the certification identifier related to the medical certification as shown in the example of the screen 1350.

According to various embodiments, the user may select an application for a data source from the selected application. For example, it may be configured such that data related to a function used in the selected application is delivered.

According to one embodiment, as shown in the example of the screen 1330, the blood pressure application may be configured such that blood pressure data is delivered from an application A which is medically certified or such that the blood pressure data is delivered from an application B which is not medically certified. In the example of the screen 1330, the blood pressure application may be configured such that blood pressure data is delivered from the application A. In case of the application A which is medically certified, the certification identifier 1335 (e.g., the green cross mark) indicating the medical certification may be displayed together. In case of the application B which is not medically certified, the certification identifier may not be provided.

According to one embodiment, as shown in the example of the screen 1350, the diagnosis application may be configured such that diagnosis data is delivered from the application A which is medically certified or such that the diagnosis data is delivered from the application B which is not medically certified. In the example of the screen 1350, the diagnosis application may be configured such that the diagnosis data is delivered from the application B.

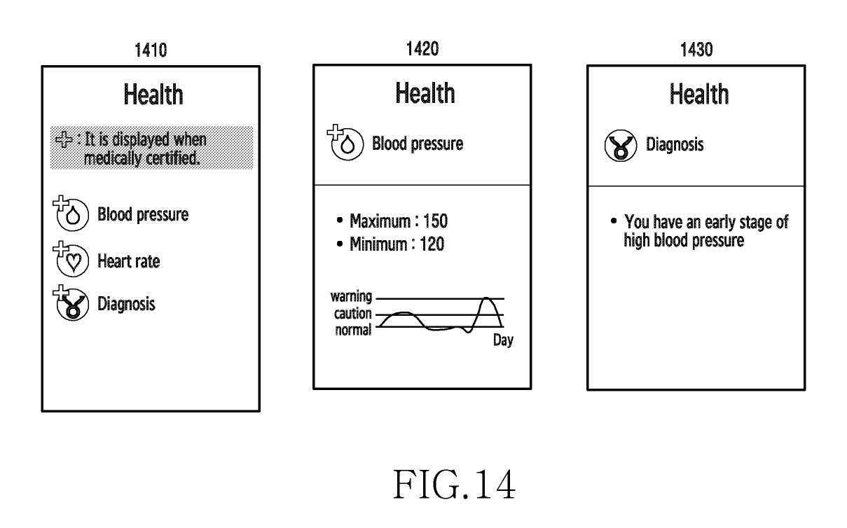

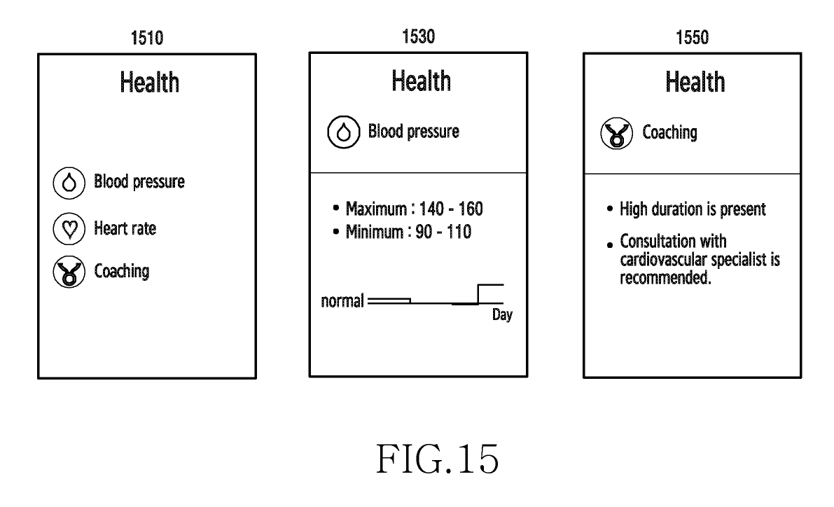

According to various embodiments, in the example of the screen 1330 or the screen 1350, a medically-certified application (e.g., the application A) can provide detailed blood pressure data or diagnosis data, and a non-medical application (e.g., the application B) which is not medically certified cannot provide the detailed blood pressure data or diagnosis data. Thus, simple data (e.g., coaching data) may be provided instead of the detailed data. An example of such a screen is illustrated in FIG. 14 and FIG. 15.

FIG. 14 and FIG. 15 illustrate an example of a screen for outputting health data in an electronic device according to various embodiments of the present disclosure.

Referring to FIG. 14 and FIG. 15, according to various embodiments, the electronic device 500 may provide data differently depending on a level (e.g., a detailed level, a type, etc.) of data to be provided to a user on the basis of whether it is medically certified. According to one embodiment, a medically certified application may generate, display, process, and/or deliver data suitable for a medical level, and in order to implement this, detailed medical information may be provided from a different module (e.g., the data processing module 650). According to one embodiment, as to a non-medical application, simple medical information may be provided from the different module (e.g., the data processing module 650) so that data is not generated, displayed, processed, and/or delivered more than it is authorized. In various embodiments, the non-medical application may process (e.g., display, deliver) data within a non-medical range, and data suitable for a medical level may be restricted not to be processed or a level thereof may be decreased through data processing.

According to one embodiment, as shown in FIG. 14, an example of a screen provided in a medical application may be shown in FIG. 14. Referring to FIG. 14, as shown in examples of a screen 1410, a screen 1430, and a screen 1450, blood pressure, heart rate, and diagnosis data may be provided by using respective medical applications which are medically certified as a source. For example, in the example of the screen 1430, blood pressure data may be provided in a form of a numeric value and a graph in detail equivalent to a medical level, and in the example of the screen 1450, diagnosis data may be provided in a form of a medical opinion in the same level as the medical level. In various embodiments, medical data such as blood pressure, heart rate, diagnosis data or the like provided as medical data may use the same or different applications as a source. For example, the medical application may provide different medical data.

According to one embodiment, as shown in FIG. 15, an example of a screen provided in a non-medical application may be shown in FIG. 15. Referring to FIG. 15, as shown in examples of a screen 1510, a screen 1530, and a screen 1550, blood pressure, heart rate, and diagnosis data may be provided by using respective non-medical applications which are not medically certified as a source. For example, in the example of the screen 1530, blood pressure data may be provided with a duration corresponding to a numeric value (e.g., data processing: categorizing is applied) instead of a detailed numeric value, and as to a group, a simplified graph (e.g., a detailed graph is subjected to data processing: simplifying is applied) may be applied. In the example of the screen 1550, as to diagnosis data, an abstract opinion or a coaching opinion (e.g., a diagnosis of a medical opinion level is subjected to data processing: abstracting and coaching are applied) may be provided instead of giving a diagnosis of a medical level.

According to various embodiments, an electronic device and an operating method thereof may decide whether health data to be accessed or provided is medically certified on the basis of a service level that can be provided by a sensor or an application, and may provide data through proper processing based on a purpose of providing the data. According to the various embodiments, the electronic device decides health data suitable for a purpose of providing data of a different electronic device upon receiving a request for the health data from the different electronic device, and may provide the health data by processing it on the basis of a result of the decision. The electronic device may decide whether the different electronic device is a medical electronic device or a non-medical electronic device on the basis of medical certification information, may translate the health data differently depending on a result of the decision, and may provide the translated data. According to the various embodiments, for various scenarios of transmitting, delivering, using, or the like of the health data, a system capable of conforming to a medical information protection act (e.g., HIPAA) can be implemented at a level of an application or module of the electronic device.

Although the present disclosure has been described with various exemplary embodiments, various changes and modifications may be suggested to one skilled in the art. It is intended that the present disclosure encompass such changes and modifications as fall within the scope of the appended claims.

What is claimed is:

1. An electronic device comprising:
a memory; and
a processor operatively coupled to the memory, wherein the processor is configured to:
receive a request for health data of a user from a first object configured to collect the health data,
confirm medical certification information corresponding to the first object,
generate translated health data by performing translation on at least one part of the health data based on the medical certification information, and
deliver the translated health data to the first object.

2. The electronic device of claim 1,
wherein the first object comprises an application, a sensor, or a second electronic device configured to collect the health data, and
wherein the health data is configured to comprise health data acquired from a second object different from the first object.

3. The electronic device of claim 1, wherein the processor is configured to:
generate the translated health data from the at least one part of the health data by using a first translation scheme if the medical certification information corresponds to first medical certification information, and
generate the translated health data from the at least one part of the health data if the medical certification information corresponds to second medical certification information.

4. The electronic device of claim 1, wherein the processor is configured to:
confirm a health data usage of the first object based on the medical certification information, and
perform the translation based on whether the health data comprises data in a wider range than a range of data corresponding to the health data usage.

5. The electronic device of claim 1, wherein the processor is configured to perform, in response to receiving the request for the health data, at least one of:
acquiring the health data by using a sensor different from the first object,
acquiring the health data from an application different from the first object, and
acquiring the health data by requesting the health data from a different electronic device.

6. The electronic device of claim 1, wherein the processor is configured to:
confirm first medical certification information stored in the electronic device, and
in response to an external electronic device being the first object, confirm second medical certification information stored in the external electronic device.

7. The electronic device of claim 1, wherein the processor is configured to perform the translation on at least one part of the health data by using at least one translation scheme among simplifying, categorizing, abstracting, and deleting.

8. The electronic device of claim 1, wherein the processor is configured to:
select a source of health data corresponding to an item configured to display health information,
determine medical certification information corresponding to the source,
display a certification identifier corresponding to the item and based on the medical certification information, and
display the health data corresponding to the item.

9. The electronic device of claim 8, wherein the processor is configured to:
in response to a selection of a medically certified application as the source, provide the health data based on detailed medical information, and
in response to a selection of an application that is not medically certified as the source, provide the health data based on simple medical information by using at least one translation scheme among simplifying, categorizing, abstracting, and deleting.

10. The electronic device of claim 9, wherein the processor is configured to:
in response to the selection of an application, determine whether the selected application is medically certified, and
display medical certification information corresponding to the selected application based on the determination.

11. A method of operating an electronic device, the method comprising:
receiving a request for health data of a user from a first object configured to collect the health data;
confirming medical certification information corresponding to the first object;
generating translated health data by performing translation on at least one part of the health data based on the medical certification information; and
delivering the translated health data to the first object.

12. The method of claim 11,
wherein the first object comprises an application, a sensor, or a second electronic device configured to collect the health data, and
wherein the health data is configured to comprise health data acquired from a second object different from the first object.

13. The method of claim 11, wherein the generating comprises:
generating the translated health data from the at least one part of the health data by using a first translation scheme if the medical certification information corresponds to first medical certification information; and
generating the translated health data from the at least one part of the health data if the medical certification information corresponds to second medical certification information.

14. The method of claim 11, wherein the generating comprises:
confirming a health data usage of the first object based on the medical certification information; and
performing the translation based on the health data comprising data in a wider range than a range of data corresponding to the usage.

15. The method of claim 11, further comprising:
in response to receiving the request for the health data, acquiring the health data by using a sensor different from the first object, acquiring the health data from an application different from the first object, or acquiring the health data by requesting to a different electronic device,.

16. The method of claim 11, wherein the confirming comprises:
confirming first medical certification information stored in the electronic device; and
in response to an external electronic device being the first object, confirming second medical certification information stored in the external electronic device.

17. The method of claim 11, wherein the performing of the translation comprises performing the translation on at least one part of the health data by using at least one translation scheme among simplifying, categorizing, abstracting, and deleting.

18. The method of claim 11, further comprising:
selecting a source of health data corresponding to an item configured to display health information;
determining medical certification information corresponding to the source;
displaying a certification identifier corresponding to the item and based on the medical certification information; and
displaying the health data corresponding to the item.

19. The method of claim 18, further comprising:
in response to a selection of a medically certified application as the source, providing and displaying the health data based on detailed medical information, and
in response to a selection of an application that is not medically certified as the source, providing and displaying the health data based on simple medical information by using at least one translation scheme among simplifying, categorizing, abstracting, and deleting.

20. The method of claim 19, wherein the displaying comprises:
in response to the selection of an application, determining whether the selected application is medically certified; and
displaying the medical certification information corresponding to the selected application based on the determination.
